(19) United States
(12) Patent Application Publication
(10) Pub. No.: US 2025/0162483 A1
(43) Pub. Date: May 22, 2025

(54) BUSHING FOR OSCILLATING FREE PIVOT

(71) Applicants: Steven PLOCH, South Lyon, MI (US); Michael KAPUSKY, South Lyon, MI (US); Matthew COOK, Commerce Township, MI (US); Sean M. SUTTON, Wixom, MI (US); Matthew S. THOMSON, Taylor, MI (US); MAGNA SEATING INC., Aurora (CA)

(72) Inventors: Steven Ploch, White Lake, MI (US); Michael Kapusky, South Lyon, MI (US); Matthew Cook, Commerce Township, MI (US); Sean M. Sutton, Wixom, MI (US); Matthew S. Thomson, Taylor, MI (US)

(21) Appl. No.: 18/839,686

(22) PCT Filed: Mar. 20, 2023
(86) PCT No.: PCT/US2023/015606

§ 371 Date: Aug. 19, 2024

Related U.S. Application Data
(60) Provisional application No. 63/321,455, filed on Mar. 18, 2022.

(51) Int. Cl. B60N 2/90; B60N 2/02; B60N 2/20; F16C 17/02; F16C 27/06

(52) U.S. Cl. CPC B60N 2/933; B60N 2/028; B60N 2/20; F16C 17/02; F16C 27/06

(57) ABSTRACT

A seat assembly for use in an automotive vehicle has a seat cushion including a seat bracket, a seat back including a side bracket, a bushing having an outer ring fixedly coupled to one of the seat bracket or the side bracket, and a free pivot pivotally coupling the seat bracket to the side bracket. The bushing has a passageway extending axially through the outer ring and a plurality of flexible fingers extending inward from the outer ring into the passageway. The free pivot includes a shaft the extending axially through the passageway in the bushing with the plurality of flexible fingers frictionally engaged with the shaft.

### CROSS-REFERENCE TO RELATED APPLICATIONS

This application claims priority to U.S. Provisional Application 3, filed on Mar. 18, 2022, the disclosure of which is hereby incorporated by reference in its entirety.

### BACKGROUND OF THE INVENTION

### 1. Field of the Invention

The present invention relates to a seat assembly for use in an automotive vehicle. More particularly, the invention relates to a seat assembly for use in an automotive vehicle and having an oscillating free pivot.

### 2. Description of Related Art

Automotive vehicles typically include one or more seat assemblies having a seat cushion and a seat back for supporting a passenger above a vehicle floor. Certain rear seat assemblies include seat backs split into inboard and outboard seat backs, such as 20/40 seat backs as is commonly known in the art. Each of the inboard and outboard seat backs include a pair of opposing side brackets pivotally coupled to the seat cushion which may allow the seat backs to be pivoted between an upright design seating position, a plurality of reclined seating positions, and a fold flat position overlapping the seat cushion.

It is commonly known that the side brackets may be pivotally coupled to the seat cushion by a manual recliner or a power recliner, such as a continuous disc recliner and the like. Alternatively, the side brackets may be pivotally coupled to the seat cushion by a free pivot. A free pivot allows unrestricted rotational movement of the side bracket relative to the seat cushion.

In some vehicles, the inboard and outboard seat backs may have one side bracket pivotally coupled to the seat cushion by a manual recliner or a power recliner and the opposing side bracket pivotally coupled to the seat cushion by a free pivot. However, the manual recliner or the power recliner can cause oscillating motion at the free pivot in response to rotational movement of the associated seat back. The oscillating motion at the free pivot may result in unacceptable observable movement between the respective pair of side brackets or between the inboard and outboard seat backs.

It is desirable, therefore, to minimize observed movement in a seat assembly having a split seat back when a free pivot is used in conjunction with a manual recliner or power recliner and the seat back is pivoted.

### SUMMARY OF THE INVENTION

According to one embodiment, there is provided a seat assembly for use in an automotive vehicle. The seat assembly comprises a seat cushion including a seat bracket, a seat back including a side bracket, a bushing, and a free pivot. The bushing includes an outer ring fixedly coupled to one of the side bracket or the seat bracket. The bushing also has a passageway extending axially through the outer ring and a plurality of flexible fingers extending inward from the outer ring into the passageway. The free pivot pivotally couples the side bracket to the seat bracket and includes a shaft extending axially through the passageway in the bushing with the plurality of flexible fingers frictionally engaged with the shaft.

According to another embodiment, there is provided a bushing for use in an automotive vehicle seat assembly. The bushing comprises an outer ring defining a center axis and having a passageway extending axially therethrough. The bushing includes spaced apart flexible fingers extending inward from the outer ring and into the passageway. The flexible fingers are tangential to an imaginary circle aligned with the center axis of the outer ring.

According to another embodiment, there is provided a bushing for use in an automotive vehicle seat assembly. The bushing comprises an outer ring including a passageway extending axially therethrough and a plurality of outer pins projecting radially inward into the passageway. The bushing also comprises an inner ring including a hole extending axially therethrough and a plurality of inner pins projecting radially outward from the inner ring. The inner ring is spaced within the passageway in the outer ring. In addition, the bushing also comprises a plurality of compression springs having opposing end openings. Each of the plurality of outer pins is at least partially inserted into one end opening of a respective one of the plurality of compression springs. Further, each of the plurality of inner pins is at least partially inserted into the opposing end opening of a respective one of the plurality of compression springs such that the inner ring is supported within the passageway of the outer ring by the plurality of compression springs.

According to another embodiment, there is provided a seat assembly for use in an automotive vehicle. The seat assembly comprises a seat cushion including a seat bracket, a seat back including a side bracket, and a bushing including an outer ring fixedly coupled to one of the seat bracket or the side bracket. The bushing also comprises an inner ring and a plurality of compression springs. The outer ring has a passageway extending axially therethrough and a plurality of outer pins projecting radially inward into the passageway. The inner ring has a hole extending axially therethrough and a plurality of inner pins projecting radially outward from the inner ring. Each of the plurality of compression springs includes opposing first and second end openings. The inner ring is positioned within the passageway in the outer ring. Each of the plurality of outer pins is at least partially inserted into the first end opening of a respective one of the plurality of compression springs. In addition, each of the plurality of inner pins is at least partially inserted into the second end opening of the respective one of the plurality of compression springs such that the inner ring is supported with the passageway in the outer ring by the plurality of compression springs, inner pins, and outer pins. The seat assembly also comprises a free pivot pivotally coupling the side bracket to the seat bracket. The free pivot comprises a shaft extending axially through the hole in the inner ring.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a seat assembly having a free pivot, according to one embodiment of the present invention;

FIG. 2 is an enlarged fragmentary perspective view of portion 2 of the seat assembly of FIG. 1 showing a bushing assembled with the free pivot, according to one embodiment of the present invention:

FIG. 3 is an exploded fragmentary perspective view of the portion of the seat assembly of FIG. 2 showing the assembly of the free pivot and the bushing:

FIG. 4 is a front view of the bushing of FIG. 3:

FIG. 5 is an enlarged cross-sectional side view of the portion of the seat assembly of FIG. 2:

FIG. 6 is an enlarged fragmentary perspective view of portion 2 of the seat assembly of FIG. 1 showing a bushing assembled with the free pivot, according to another embodiment of the present invention:

FIG. 7 is an exploded fragmentary perspective view of the portion of the seat assembly of FIG. 6 showing the assembly of the free pivot and the bushing:

FIG. 8 is a front view of the bushing of FIG. 6; and

FIG. 9 is an enlarged cross-sectional side view of the portion of the seat assembly of FIG. 6.

### DETAILED DESCRIPTION OF THE EMBODIMENTS

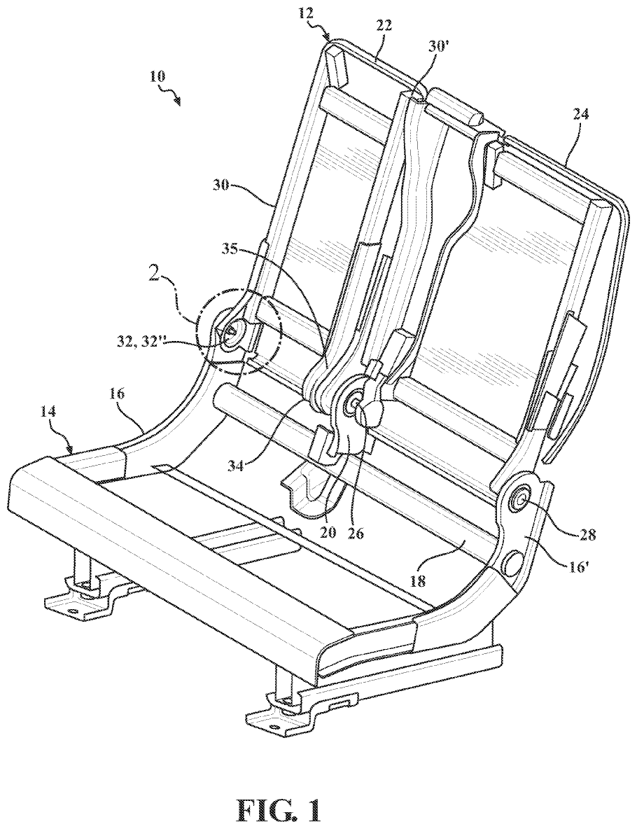

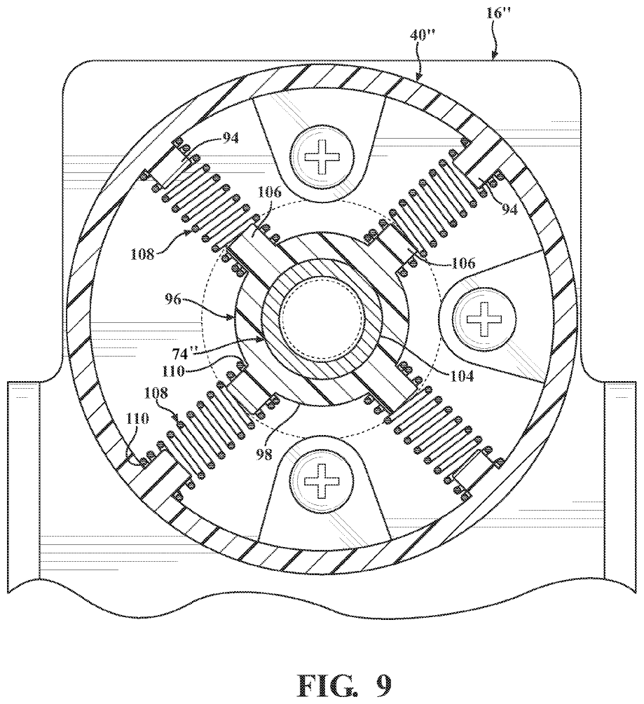

FIGS. 1-9 illustrate components of a seat assembly 10 for use in an automotive vehicle according to embodiments described herein. Directional references employed or shown in the description, figures, or claims, such as top, bottom, upper, lower, upward, downward, lengthwise, widthwise, left, right, and the like, are relative terms employed for ease of description and are not intended to limit the scope of the invention in any respect. Referring to the Figures, like numerals indicate like or corresponding parts throughout the several views.

As depicted in FIG. 1, the seat assembly 10 includes a seat back 12 and a seat cushion 14. The seat cushion 14 includes a pair of laterally spaced apart inboard and outboard seat brackets 16, 16′ and a transverse tube 18 extending between the seat brackets 16, 16′. A center bracket 20 is fixedly coupled to the transverse tube 18 and spaced between the seat brackets 16, 16′. The seat back 12 is a split seat back, commonly described as a 20/40 seat back, comprising inboard and outboard seat backs 22, 24 supported between the seat brackets 16, 16′. The inboard and outboard seat backs 22, 24 may pivot between an upright design seating position, a plurality of reclined seating positions, and a fold flat position overlapping the seat cushion 14 as is commonly known in the art. The outboard seat back 24 is pivotally connected to the center bracket 20 and the outboard seat bracket 16′ by a center pivot 26 and an outboard pivot 28, respectively.

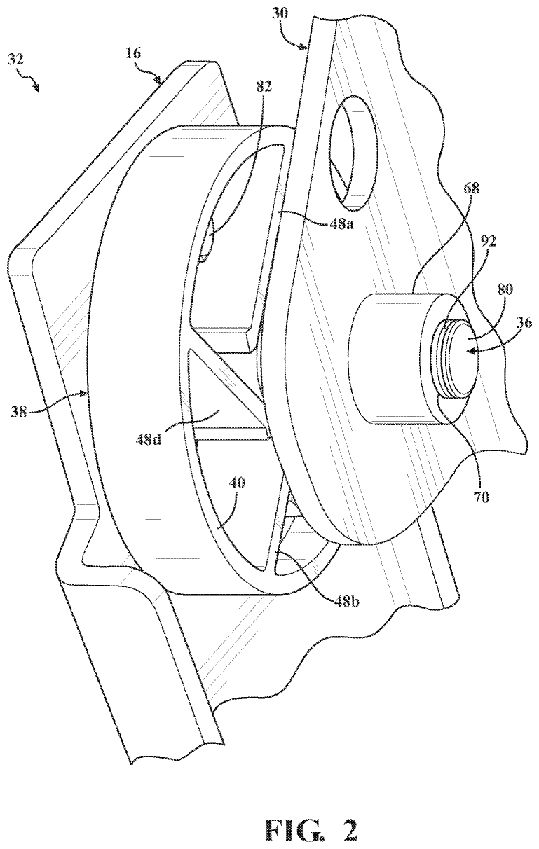

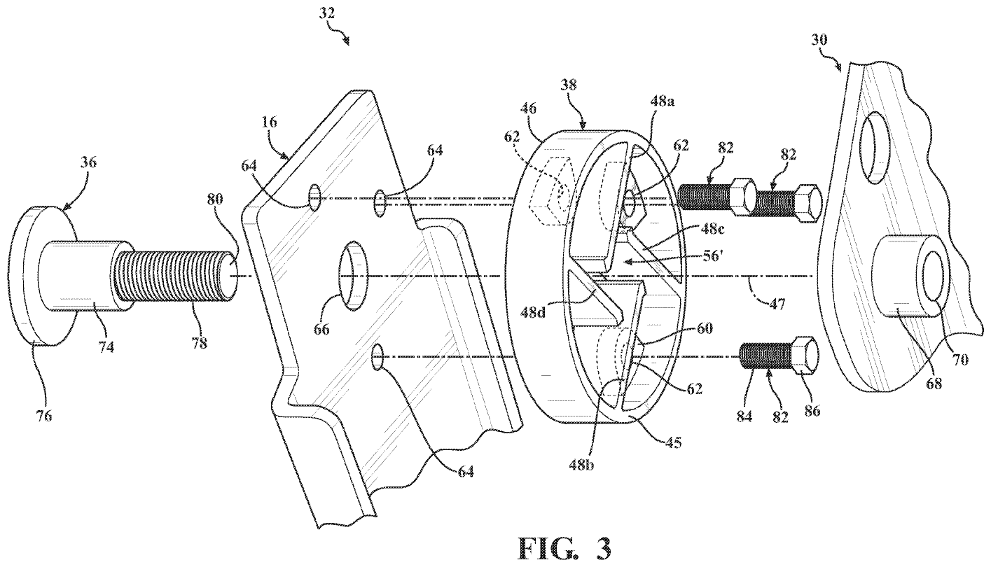

The inboard seat back 22 includes a pair of spaced apart left and right side brackets 30, 30′ pivotally connected to the inboard seat bracket 16 and the center bracket 20 by a free pivot 32 and a right pivot 34, respectively. The right pivot 34 includes a continuous disc recliner 35, a manual recliner, a power recliner, or the like, pivotally coupling the right side bracket 30′ to the center bracket 20 as is commonly known in the art. Depicted in FIGS. 1 and 2, the free pivot 32 is configured such that the left side bracket 30 may freely pivot relative to the inboard seat bracket 16. Referring to FIGS. 2 and 3, the free pivot 32 includes a shoulder bolt 36 pivotally coupling an upper portion of the inboard seat bracket 16 to a lower portion of the left side bracket 30. The free pivot 32 also includes a bushing 38 spaced between the inboard seat bracket 16 and the left side bracket 30, as further described below. The free pivot 32 may be configured as a concentric free pivot or a non-concentric free pivot without altering the scope of the present invention.

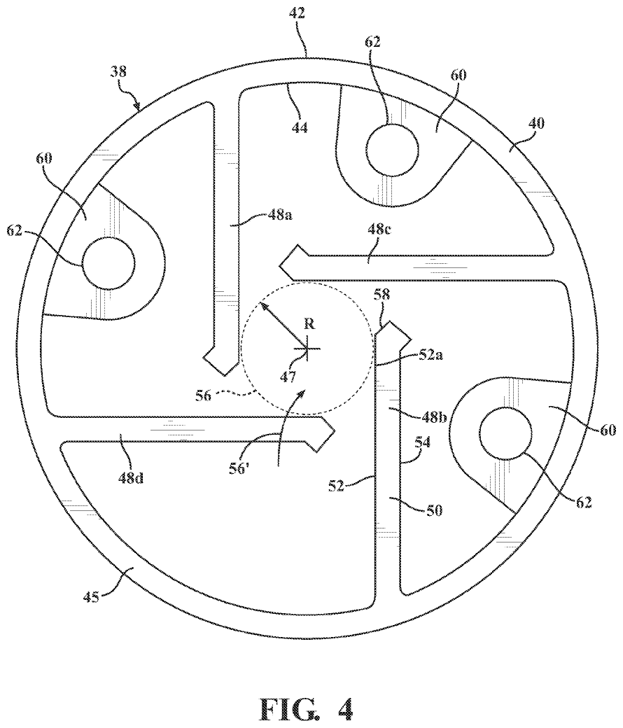

Referring to FIGS. 3 and 4, the bushing 38 includes an outer ring 40 having an exterior ring surface 42 spaced radially apart from an interior ring surface 44 and extending between front and rear ring surfaces 45, 46. The exterior ring surface 42 defines a center axis 47 of the bushing 38. A plurality of spaced apart flexible fingers 48a-48d extend radially inward from the interior ring surface 44. Each of the flexible fingers 48a-48d includes a leg portion 50 having opposing proximal and distal sides 52, 54. The flexible fingers 48a-48d are shaped such that end portions 52a of the proximal sides 52 are generally tangential to an imaginary circle 56 having a radius R and having a central axis aligned with the center axis 47 of the bushing 38. Further, the proximal sides 52 are offset from the center axis 47. As such, there is a gap between the flexible fingers 48a-48d defining a passageway 56′ extending axially through the bushing 38. In addition, each flexible finger 48a-48d includes a lead-in portion 58 extending at an angle from the proximal side 52 and extending towards the outer ring 40. The flexible fingers 48a-48d are configured to bend or flex slightly, the purpose of which is further described below.

In the embodiment shown in FIG. 4, the plurality of flexible fingers 48a-48d includes four spaced apart fingers 48a-48d, however the number, shape, position, and size of the flexible fingers 48a-48d may vary without altering the scope of the present invention. The first finger 48a and the second finger 48b extend inward from the outer ring 40 and oppose each other. The first and second fingers 48a, 48b are spaced radially apart from the center axis 47 of the bushing 38 with the center axis 47 passing radially between the first and second fingers 48a, 48b. In one embodiment, the first finger 48a is generally parallel to the second finger 48b. In addition, the third finger 48c and the fourth finger 48d extend inward from the outer ring 40 and oppose each other. The third and fourth fingers 48c, 48d are spaced radially apart from the center axis 47 of the bushing 38 with the center axis 47 passing between the third and fourth fingers 48c, 48d. Further, the third and fourth fingers 48c, 48d are oriented at a generally right angle to the first and second fingers 48a, 48b.

Also shown in FIG. 4, the bushing 38 includes a plurality of spaced apart mounting tabs 60 projecting radially inward from the interior ring surface 44 adjacent the rear ring surface 46. A mounting hole 62 extends axially through each mounting tab 60. In the embodiment shown in FIGS. 2-5, the bushing 38 includes three spaced apart mounting tabs 60. However, the number, shape, position, and size of the mounting tabs 60 may vary without altering the scope of the present invention.

Referring to FIG. 3, the inboard seat bracket 16 includes a plurality of spaced apart attachment holes 64 corresponding to the number of mounting holes 62 in the bushing 38. The attachment holes 64 extend laterally through the seat bracket 16 and are configured to align with the mounting holes 62 in the bushing 38. In addition, the inboard seat bracket 16 includes a pivot hole 66 extending laterally therethrough and having a center axis configured to axially align with the center axis 47 of the bushing 38 when the attachment holes 64 are aligned with the mounting holes 62. Also shown in FIG. 3, the left side bracket 30 includes a cylindrically shaped boss 68 extending laterally from the side bracket 30 and having an aperture 70 extending axially therethrough.

Depicted in FIG. 3, the shoulder bolt 36 includes a cylindrical shaft 74 extending axially from a bolt head 76. The shoulder bolt 36 also includes a threaded shaft 78 extending axially from the cylindrical shaft 74 and terminating at a bolt end 80. The cylindrical shaft 74 is configured to pass into the pivot hole 66 in the inboard seat bracket 16 and into the passageway 56′ in the bushing 38 between the flexible fingers 48a-48d. The threaded shaft 78 is configured to pass through the pivot hole 66 in the inboard seat bracket 16, through the passageway 56′ in the bushing 38 between the flexible fingers 48a-48d, and into the aperture 70 in the side bracket 30.

The free pivot 32 of FIG. 3 also includes plurality of fasteners 82 corresponding to the number of mounting holes 62 in the bushing 38. Each fastener 82 includes a threaded shaft 84 extending from a bolt head 86. The threaded shafts 84 are configured to pass through the mounting holes 62 in the bushing 38 and fixedly couple with the respective attachment holes 64 in the inboard seat bracket 16.

Assembly of the free pivot 32 is described with reference to FIGS. 3-5. Referring to FIG. 3, the free pivot 32 is assembled by aligning the mounting holes 62 in the bushing 38 with the respective attachment holes 64 in the inboard seat bracket 16 with the rear ring surface 46 of the bushing 38 abutting or adjacent to the inboard seat bracket 16. Next, the bushing 38 is fixedly coupled to the seat bracket 16 by inserting the threaded shafts 84 of the fasteners 82 through the respective mounting holes 62 in the bushing 38 and fixedly coupling the fasteners 82 to the respective attachment holes 64 in the seat bracket 16. The bolt head 86 of the fasteners 82 may frictionally engage with the respective mounting tabs 60 when the bushing 38 is fixedly coupled to the seat bracket 16.

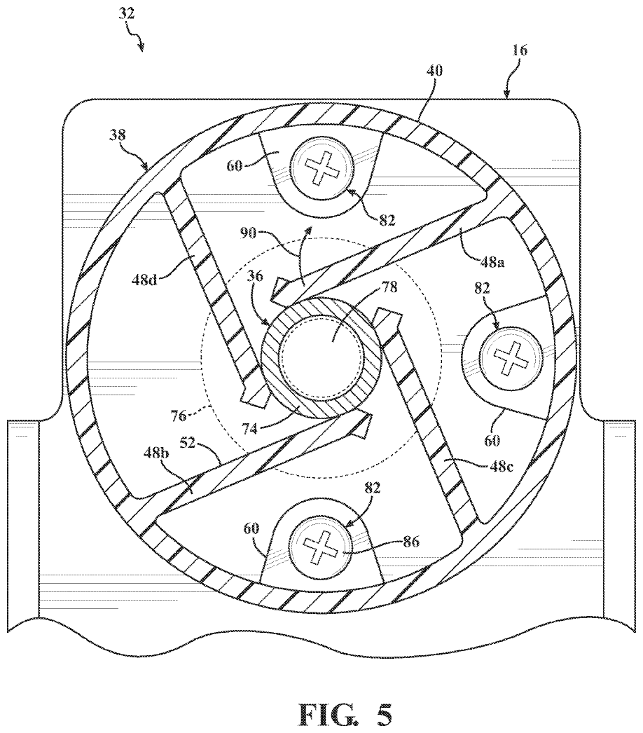

After the bushing 38 is attached to the seat bracket 16, the bolt end 80 of the shoulder bolt 36 is inserted through the pivot hole 66 in the seat bracket 16, through the passageway 56′ in the bushing 38, and into the aperture 70 in the left side bracket 30. One or more of the flexible fingers 48a-48d may deflect radially outward as the cylindrical shaft 74 of the shoulder bolt 36 is inserted between the flexible fingers 48a-48d, as illustrated by arrow 90 in FIG. 5. The radius R of the imaginary circle 56 for the bushing 38 may be selected such that there is a frictional fit between the flexible fingers 48a-48d and the cylindrical shaft 74 when the bushing 38 is assembled with the shoulder bolt 36. In one embodiment, the radius R is selected to be equal to or less than the radius of the cylindrical shaft 74 causing the flexible fingers 48a-48d to flex outward (arrow 90) as the shoulder bolt 36 is inserted into the bushing 38. The outward flexing (arrow: 90) of the flexible fingers 48a-48d spring-biases the flexible fingers 48a-48d towards the shoulder bolt 36 retaining the flexible fingers 48a-48d frictionally engaged with the cylindrical shaft 74.

Referring to FIG. 2, the threaded shaft 78 of the shoulder bolt 36 is fixedly coupled or pivotally coupled to the seat bracket 30 in alternate embodiments of the present invention. The threaded shaft 78 may include a slot 92 near the bolt end 80 for inserting a retaining clip (not shown) as is commonly known in the art. In an alternate embodiment, a nut (not shown) is fastened to the bolt end 80.

When the inboard seat back 22 is pivoted, the continuous disc recliner 35 of the right pivot 34 may cause an oscillating motion of the left side bracket 30 relative to the inboard seat bracket 16, resulting in oscillating motion of the shoulder bolt 36 within the free pivot 32. The flexible fingers 48a-48d bend slightly back and forth in response to the oscillating motion of the shoulder bolt 36 and absorb oscillations caused by the seat back 22 rotational motion. The movement of the flexible fingers 48a-48d in response to the oscillating motion of the shoulder bolt 36 reduces the perceived oscillating movement of the left side bracket 30 relative to the seat bracket 16.

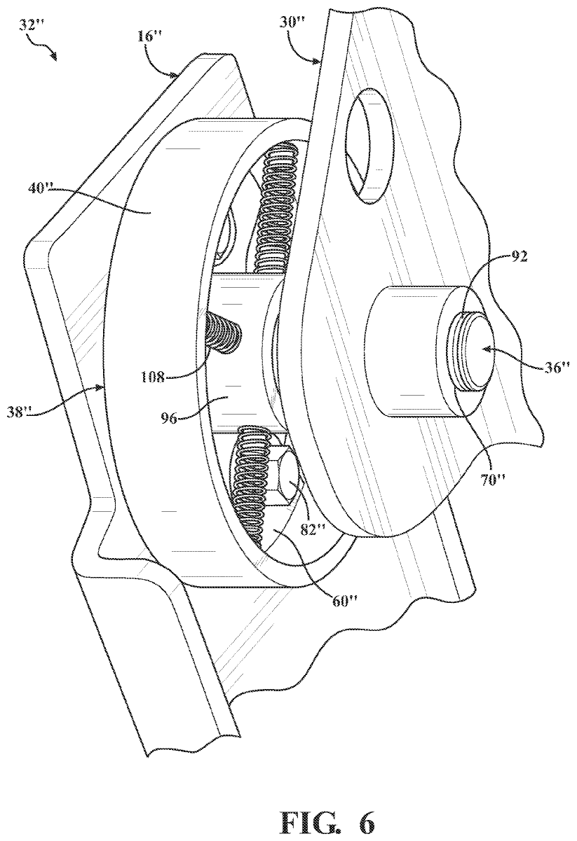

A second embodiment of the free pivot 32″ is shown in FIGS. 6-9, wherein like double primed reference numerals represent similar elements as those described above. The second embodiment shown in FIGS. 6-9 depicts a bushing 38″ in place of the bushing 38 shown in FIGS. 2-5. Only significant differences between the two embodiments are reflected in the Figures and the description below.

Referring to FIGS. 6-8, the bushing 38″ includes an outer ring 40″ having a plurality of spaced apart outer pins 94 and a plurality of mounting tabs 60″ projecting radially inward from an interior ring surface 44″. Each of the mounting tabs 60″ includes a mounting hole 62″ extending axially therethrough.

The bushing 38″ also includes an inner ring 96 having an exterior surface 98 extending between front and rear end surfaces 100, 102 and a hole 104 extending axially through the inner ring 96. The diameter of the hole 104 in the inner ring 96 is selected such that the cylindrical shaft 74″ of the shoulder bolt 36″ can pass into the hole 104. In addition, the inner ring 96 includes a plurality of spaced apart inner pins 106 projecting radially from the exterior surface 98. The number of inner pins 106 corresponds to the number of outer pins 94.

The bushing 38″ also includes a plurality of compression springs 108 corresponding to the number of outer pins 94. The compression springs 108 include opposing first and second end openings 110 having an inner diameter generally equal to or greater than an outer diameter of the inner and outer pins 94, 106. In the embodiment shown in FIGS. 6-9, there are four sets of outer pins 94, inner pins 106, and compression springs 108. It will be appreciated that the numbers of sets of outer pins 94, inner pins 106, and compression springs 108 may vary without altering the scope of the present invention.

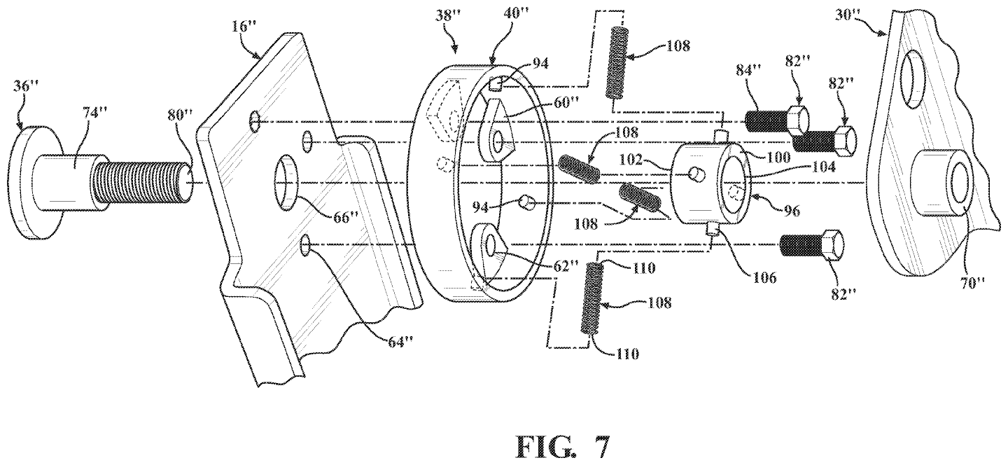

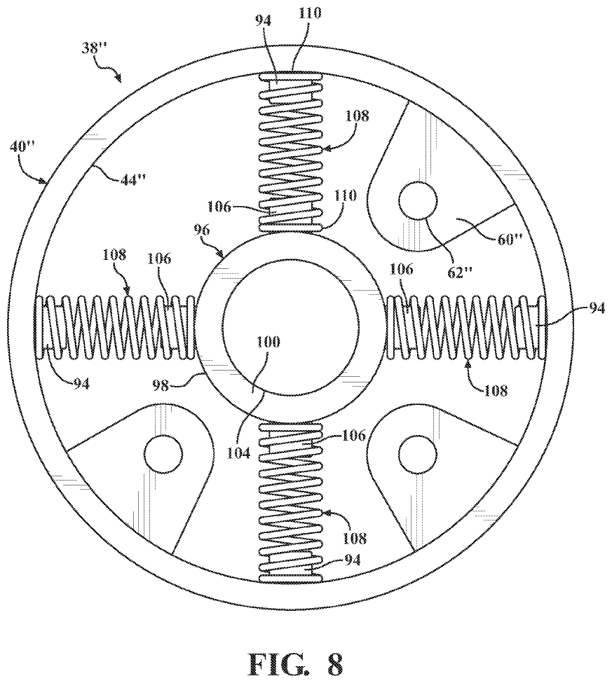

Referring to FIGS. 7 and 8, the bushing 38″ is assembled by inserting the outer pins 94 of the outer ring 40″ into the first end openings 110 of the associated compression springs 108. Next, the inner pins 106 of the inner ring 96 are inserted into the second end openings 110 of the compression springs 108 such that the inner ring 96 is supported by the compression springs 108 within the outer ring 40″. The bushing 38″ is shown fully assembled in FIG. 8.

Referring to FIG. 7, the assembled bushing 38″ is fixedly coupled to the inboard seat bracket 16″ by inserting the threaded shafts 84″ of the fasteners 82″ through the mounting holes 62″ in the outer ring 40″ and fixedly coupling the fasteners 82″ to the respective attachment holes 64″ in the inboard seat bracket 16″. Next, the bolt end 80″ of the shoulder bolt 36″ is inserted through the pivot hole 66″ in the inboard seat bracket 16″, through the passageway 104 in the inner ring 96 of the bushing 38″, and into the aperture 70″ in the left side bracket 30″.

The compression springs 108 of the bushing 38″ absorb the oscillating motion of the shoulder bolt 36″ within the free pivot 32″ in response to rotational motion of the inboard seat back 22. As the inboard seat back 22 is rotated by the continuous disc recliner 35, the compression springs 108 allow floating of the free pivot 32″ and allow the seat back 22 movement to be perceived as minimal.

As discussed above, the free pivot 32, 32″ of the present invention includes a bushing 38, 38″ that absorbs the oscillating motion within the free pivot 32, 32″ in response to rotational motion of the seat back 22. The bushing 38, 38″ reduces the observable motion between the inboard and outboard seat backs 22, 24 when a free pivot 32, 32″ is used in conjunction with a manual recliner or a power recliner.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed is:

1. A seat assembly for use in an automotive vehicle, the seat assembly comprising:
a seat cushion including a seat bracket;
a seat back including a side bracket;
a bushing including an outer ring fixedly coupled to one of the side bracket or the seat bracket, a passageway extending axially through the outer ring, and a plurality of flexible fingers extending inward from the outer ring into the passageway; and
a free pivot pivotally coupling the side bracket to the seat bracket, the free pivot comprising a shaft extending axially through the passageway in the bushing with the plurality of flexible fingers frictionally engaged with the shaft.

2. The seat assembly as set forth in claim 1, wherein:
each of the plurality of flexible fingers includes a leg portion extending from the outer ring and having a proximal side frictionally engaged with the shaft.

3. The seat assembly as set forth in claim 2, wherein:
each of the plurality of flexible fingers includes a lead-in portion adjacent the proximal side.

4. The seat assembly as set forth in claim 2, wherein:
the plurality of flexible fingers includes a first finger and a second finger extending inward from the outer ring, the first finger and the second finger spaced radially apart from a center axis of the bushing with the center axis passing radially between the first finger and the second finger.

5. The seat assembly as set forth in claim 4, wherein:
the first finger and the second finger are generally parallel to one another.

6. The seat assembly as set forth in claim 5, wherein:
the plurality of flexible fingers includes a third finger and a fourth finger extending inward from the outer ring, the third finger and the fourth finger spaced radially apart from the center axis of the bushing with the center axis passing radially between the third finger and the fourth finger.

7. The seat assembly as set forth in claim 6, wherein:
the third finger and the fourth finger are generally parallel to one another.

8. The seat assembly as set forth in claim 7, wherein:
the third finger and the fourth finger are oriented at a generally right angle to the first finger and the second finger.

9. A bushing for use in an automotive vehicle seat assembly, the bushing comprising:
an outer ring defining a center axis and having a passageway extending axially therethrough; and
spaced apart flexible fingers extending inward from the outer ring and into the passageway, wherein the flexible fingers are tangential to an imaginary circle aligned with the center axis of the outer ring.

10. The bushing as set forth in claim 9, further comprising a mounting tab projecting from the outer ring and having a mounting hole extending axially therethrough.

11. The bushing as set forth in claim 9, wherein the flexible fingers include a first finger opposing a second finger and a third finger opposing a fourth finger.

12. The bushing as set forth in claim 11, wherein the third finger and the fourth finger are oriented at a generally right angle to the first finger and the second finger.

13. A bushing for use in an automotive vehicle seat assembly, the bushing comprising:
an outer ring including a passageway extending axially therethrough and a plurality of outer pins projecting radially inward into the passageway;
an inner ring including a hole extending axially therethrough and a plurality of inner pins projecting radially outward from the inner ring, wherein the inner ring is spaced within the passageway in the outer ring; and
a plurality of compression springs having opposing first and second end openings, each of the plurality of outer pins is at least partially inserted into the first end opening of a respective one of the plurality of compression springs, and each of the plurality of inner pins is at least partially inserted into the second end opening of the respective one of the plurality of compression springs such that the inner ring is supported within the passageway of the outer ring by the plurality of compression springs.

14. The bushing as set forth in claim 13, wherein:
the plurality of outer pins comprises four outer pins;
the plurality of inner pins comprises four inner pins; and
the plurality of compression springs comprises four compression springs.

15. The bushing as set forth in claim 14, wherein the outer ring further includes at least one mounting tab.

16. A seat assembly for use in an automotive vehicle, the seat assembly comprising:
a seat cushion including a seat bracket;
a seat back including a side bracket;
a bushing including an outer ring fixedly coupled to one of the seat bracket or the side bracket, an inner ring, and a plurality of compression springs, the outer ring having a passageway extending axially therethrough and a plurality of outer pins projecting radially inward into the passageway, the inner ring having a hole extending axially therethrough and a plurality of inner pins projecting radially outward from the inner ring, and each of the plurality of compression springs including opposing first and second end openings, wherein the inner ring is positioned within the passageway in the outer ring, each of the plurality of outer pins is at least partially inserted into the first end opening of a respective one of the plurality of compression springs, and each of the plurality of inner pins is at least partially inserted into the second end opening of the respective one of the plurality of compression springs such that the inner ring is supported with the passageway in the outer ring by the plurality of compression springs, inner pins, and outer pins; and
a free pivot pivotally coupling the side bracket to the seat bracket, the free pivot comprising a shaft extending axially through the hole in the inner ring.

17. The seat assembly as set forth in claim 16, wherein:
the plurality of outer pins comprises four outer pins;
the plurality of inner pins comprises four inner pins; and
the plurality of compression springs comprises four compression springs.
